(19) United States
(12) Patent Application Publication
(10) Pub. No.: US 2006/0292398 A1
(43) Pub. Date: Dec. 28, 2006

(54) Method of protecting contacting surfaces between two metal parts benefiting from such protection

(75) Inventors: Joel Vigneau, Champcueil (FR); Leonid Lesnevskiy, Moscow (RU); Alexander Troshin, Moscow (RU)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SNECMA MOTEURS, Paris (FR)

(21) Appl. No.: 11/171,324

(22) Filed: Jul. 1, 2005

(30) Foreign Application Priority Data
Jul. 7, 2004 (FR) 04 07521

(51) Int. Cl. B32B 9/00

(52) U.S. Cl. 428/698

(57) ABSTRACT

Protecting the contacting surfaces of two metal parts subjected to relative movements. The method consists in covering at least one of said surfaces in a composite self-lubricating material constituted exclusively by particles of graphite distributed in a nickel matrix.

The invention relates to a method of protecting contacting surfaces between two metal parts subjected to relative displacements of small amplitude. The invention relates more particularly to the field of turbojets, and specifically to assembling blades to a rotor disk of a fan, with the roots of the blades being retained in sockets defined in the periphery of the disk. The invention also relates to a compressor, or to a turbojet fan, provided with such protection.

### BACKGROUND OF THE INVENTION

In an airplane engine, it is known to combat the wear caused by small amplitude movements between the rotor disk and the roots of the fan blades by using a coating of CuNiln on the bearing surfaces of the blade roots that come into contact with the inside surfaces of the disk sockets in which said blade roots are engaged. That technology is no longer suitable for more recent engines in which the blades are more heavily loaded. The coating that has been used until now wears too quickly and degradation of the parts in contact is observed, in particular degradation of the bearing surfaces of the disk. The disk runs the risk of cracking, and that can have the consequence of the disk itself shattering.

### OBJECTS AND SUMMARY OF THE INVENTION

The invention is the result of research into a novel type of coating that is stronger and suitable for replacing the CuNiln coating. In a different technical field, i.e. that of piston engines, it is known to treat the inside surface of a bore by depositing a layer of self-lubricating material made up of particles of a mixture of molybdenum disulfide and graphite, said particles being distributed in a nickel matrix. That lubricating mixture is described in U.S. Pat. No. 5,358,753 and is suitable for combating wear caused by large amplitude relative displacement between two contacting parts, specifically a piston and a piston sleeve. The invention proposes another solid lubricant formulation that is better adapted to wear of the fretting type as caused by small amplitude displacements between the parts in contact.

More particularly, the invention provides a method of protecting contacting surfaces between two metal parts that are subjected to relative movements of small amplitude, the method comprising an operation consisting in covering at least one of said surfaces in a composite self-lubricating material constituted exclusively by particles of graphite distributed in a nickel matrix.

Such a self-lubricating material is deposited at least on the contact zones of blade roots engaged in the sockets of the fan rotor disk.

Application may be implemented by conventional thermal spraying of a powder, with the grains of said powder being constituted by nickel-coated graphite particles. Advantageously, said thermal spraying is plasma spraying.

In a turbofan engine, the metal substrate on which the self-lubricating material is applied (on the blade root) is generally made of a titanium alloy. Adhesion of the above-defined self-lubricating material is, in theory, satisfactory. However, if it is desired to improve this adhesion, it is possible to apply a bonding underlayer on the surface that is to be covered prior to applying said self-lubricating material. This bonding underlayer may be constituted by nickel aluminum, for example. This material generally bonds well on any metal substrate. It can be applied by thermal spraying, in which case it presents morphology that contributes to retaining other sprayed materials, and in particular the nickel graphite self-lubricating material.

The method may be associated with an operation consisting in spraying another solid lubricating material on the surface of said composite self-lubricating material, which other material may be molybdenum disulfide or graphite, for example. This additional solid lubricant forms a continuous layer that is most favorable to reducing friction. This layer bonds well on the nickel graphite composite self-lubricating material because of the morphology of the deposit which includes a certain amount of porosity.

The thermal spraying of the various materials described above is advantageously performed by plasma spraying, but it could also be performed using other known systems, including by laser.

The invention also provides a turbojet fan comprising a rotary disk and blades mounted at the periphery of the disk, said disk having sockets in which blade roots are engaged, wherein at least the contact zones of the blade roots are covered in a coating comprising a layer of composite self-lubricating material constituted exclusively by particles of graphite coated in a nickel matrix.

### BRIEF DESCRIPTION OF THE DRAWINGS

The invention will be better understood and other advantages will appear better in the light of the following description given purely by way of example and made with reference to the accompanying drawing, in which:

FIG. 1 shows the structure of a powder grain for forming a layer of composite self-lubricating material on the surface of a metal part that is to be protected;

FIG. 2 is a diagrammatic section view through a surface treated in accordance with the invention;

FIG. 3 shows the implementation of a step in the method for treating a blade root; and

FIG. 4 is a diagrammatic and fragmentary view of a fan in accordance with the invention.

### MORE DETAILED DESCRIPTION

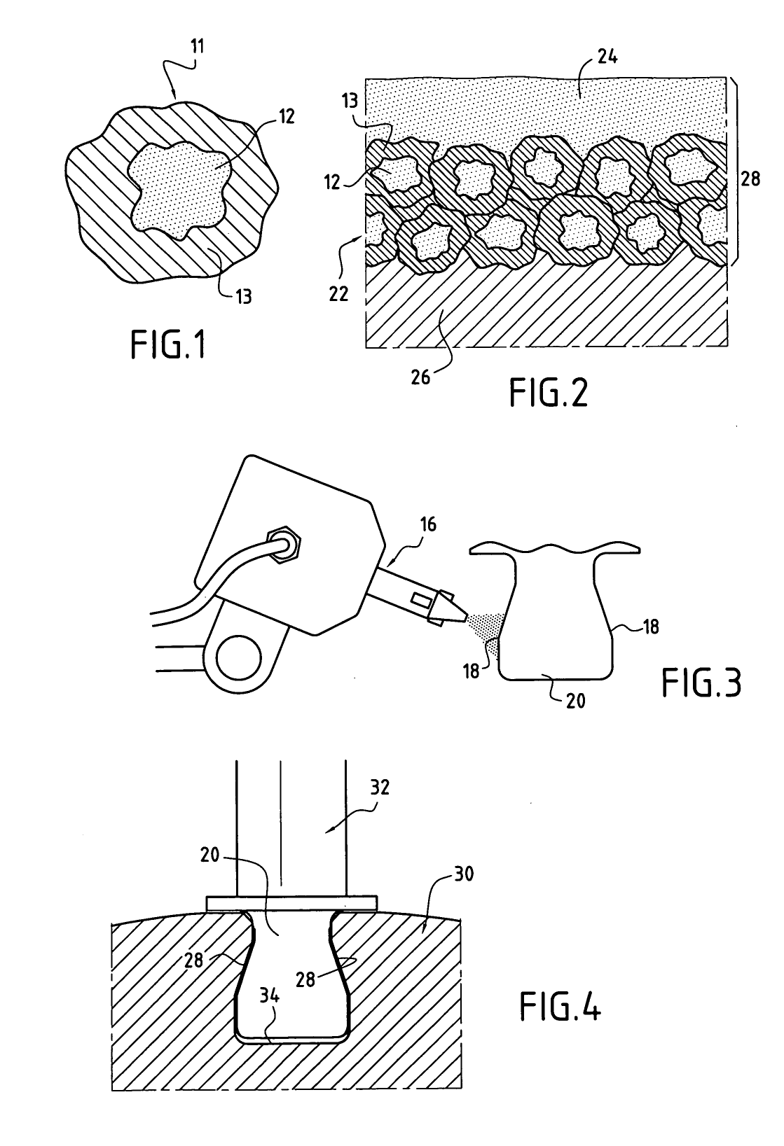

In order to implement the invention, it is preferable to use a known powder in which each grain 11 has the structure as shown in FIG. 1, i.e. is a particle of graphite 12 coated in nickel 13. Satisfactory results have been obtained from such a powder with grain sizes lying in the range 20 micrometers (μm) to 100 μm. The proportion by weight of graphite may lie in the range 10% to 40%.

Nevertheless, grain size could be much smaller, of nanometer order, providing the thermal spraying method, as described below, is adapted to said grain size.

In the embodiment that is described more particularly, the powder is sprayed thermally, advantageously by plasma spraying. This spraying (FIG. 3) is performed using a conventional plasma torch 16 on the contact zones 18 of the blade roots 20. It should be recalled that blade roots are portions of the blades of a fan that are engaged in sockets in a rotor disk of said fan. As shown in FIG. 2, spraying the powder while hot leads to a layer of composite self-lubricating material 32 being formed on the contact zone in question, which layer is thus made up of graphite particles distributed in a nickel matrix. During thermal spraying, the grains become welded to one another by the nickel melting, such that the thickness of the layer of self-lubricating material has a multitude of particles of graphite embedded therein that are regularly distributed within the nickel.

The method may be finished off by spraying another solid lubricating material 24 onto the surface of the composite self-lubricating material as deposited in this way, said other material forming a uniform layer adhering to the surface of the nickel graphite layer 22. This other solid lubricating material may be molybdenum disulfide or graphite, in particular, or it may be mixture of both of them. It adheres well to the previously-deposited nickel graphite layer. The thickness of this additional solid lubricant may lie in the range 10 μm to 50 μm.

This additional layer improves the lubricating action of the nickel graphite layer, with the nickel graphite layer beginning to act in full only once the uniform solid lubricant has been consumed. The lifetime of the contact before any degradation occurs is thus increased. When using this new type of coating 28 comprising at least the layer 22, preferably the layer 24, and optionally a bonding sublayer (not shown), tests have shown that the lifetime of the turbofan, prior to repairing its blade roots, can be multiplied by ten.

The thickness of the nickel graphite layer 22 may lie in the range 50 μm to 200 μm. It may be deposited directly on the metal substrate 26, i.e. onto the metal constituting the blade root 20, specifically a titanium alloy. Nevertheless, if it is desired to increase bonding between the nickel graphite layer and the metal substrate, it is possible (prior to depositing the nickel graphite layer) to spray a bonding underlayer, e.g. of nickel aluminum.

The invention also provides a turbojet fan comprising a rotor disk 30 and blades 32 mounted at the periphery of the disk. The disk includes sockets 34 in which the blade roots are engaged, and the contact zones of the blade roots are covered in a coating 28 in accordance with the above description, comprising at least one layer of composite self-lubricating material constituted exclusively by graphite particles distributed in a nickel matrix. The coating may include another layer of solid lubricant covering the composite self-lubricating material layer (as shown in FIG. 2). This other layer may comprise graphite and/or molybdenum disulfide.

A bonding underlayer, e.g. made of nickel aluminum, may be deposited on the blade roots (conventionally made of titanium alloy) under the above-described layer of composite self-lubricating material.

Comparative tests have been performed under the following conditions. Fan blade roots were treated as described above. Others were coated in conventional CuNiln. The blades were mounted on a single disk which was tested on an engine for 8000 cycles. At the end of this period, the CuNiln coated blade roots could be seen to be damaged by wear and the coating could be seen to be flaking away, whereas the blade roots that had been treated in accordance with the invention had suffered no degradation.

For depositing the NiGr, the following operations conditions have given satisfaction:
plasma spraying: 400 amps (A) at 55 volts (V);
grain size of the NiGr powder: 50 μm;
nozzle-to-part distance: 120 millimeters (mm);
spraying speed: 320 millimeters per second (mm/s);
displacement between two passes: 6 mm; and
thickness of layer: 150 μm.

What is claimed is:

1. A method of protecting contacting surfaces between two metal parts that are subjected to relative movements of small amplitude, the method comprising an operation consisting in covering at least one of said surfaces in a composite self-lubricating material constituted exclusively by particles of graphite distributed in a nickel matrix.

2. A method according to claim 1, wherein such a self-lubricating material is used to cover the contact zones of the blade roots of a turbojet compressor.

3. A method according to claim 1, consisting in thermally spraying a powder, the grains of said powder being constituted by particles of graphite coated in nickel.

4. A method according to claim 3, wherein said thermal spraying is plasma spraying.

5. A method according to claim 3, wherein the grain size of said powder lies in the range 20 μm to 100 μm.

6. A method according to claim 1, wherein the fraction by weight of graphite lies in the range 10% to 40%.

7. A method according to claim 1, including an operation consisting in depositing a bonding underlayer on the metal part, prior to applying said self-lubricating material.

8. A method according to claim 7, wherein said bonding underlayer is made of nickel aluminum.

9. A method according to claim 1, including an operation consisting in spraying at least one other solid lubricating material onto the surface of said composite self-lubricating material.

10. A method according to claim 9, wherein such a solid lubricating material comprises molybdenum disulfide.

11. A method according to claim 9, wherein such a solid lubricating material comprises graphite.

12. A turbojet fan comprising a rotary disk and blades mounted at the periphery of the disk, said disk having sockets in which blade roots are engaged, wherein at least the contact zones of the blade roots are covered in a coating comprising a layer of composite self-lubricating material constituted exclusively by particles of graphite coated in a nickel matrix.

13. A fan according to claim 12, wherein said coating includes a bonding underlayer, e.g. of nickel aluminum.

14. A fan according to claim 12, wherein said coating includes another layer of solid lubricant covering said layer of composite self-lubricating material.

15. A fan according to claim 14, wherein said other layer comprises graphite and/or molybdenum disulfide.
